(19) United States
(12) Patent Application Publication
(10) Pub. No.: US 2022/0185151 A1
(43) Pub. Date: Jun. 16, 2022

(54) RELEASE BAR ASSEMBLY FOR SEATING ASSEMBLY

(71) Applicant: Ford Global Technologies, LLC, Dearborn, MI (US)

(72) Inventors: Johnathan Andrew Line, Northville, MI (US); Ratan Howlader, Novi, MI (US); Spencer Robert Hoernke, Dundas (CA); Macit Aktas, Windsor (CA); Joseph Michael Kish, Canton, MI (US)

(73) Assignee: Ford Global Technologies, LLC, Dearborn, MI (US)

(21) Appl. No.: 17/122,291

(22) Filed: Dec. 15, 2020

(51) Int. Cl. B60N 2/08; B60N 2/01

(52) U.S. Cl. CPC B60N 2/0881; B60N 2/0806; B60N 2/01

(57) ABSTRACT

A bench seating assembly for a vehicle includes an outboard seating assembly disposed on a pair of outboard rails slidably coupled to a pair of outboard tracks and an inboard seating assembly disposed on an inboard rail slidably coupled to an inboard track. A release bar assembly is disposed below the outboard seating assembly and the inboard seating assembly, and includes a driver movable between a first position and a second position. A latch mechanism is operably coupled to the driver such that if the driver is in the first position, then the latch mechanism is in a locked position, and if the driver is in the second position, then the latch mechanism is in an unlocked position.

### FIELD OF THE DISCLOSURE

The present disclosure generally relates to a release bar assembly for a seating assembly.

### BACKGROUND OF THE DISCLOSURE

A seating assembly may include a release bar assembly for moving the seating assembly in a fore and aft direction.

### SUMMARY OF THE DISCLOSURE

According to one aspect of the present disclosure, a bench seating assembly for a vehicle includes an outboard seating assembly disposed on a pair of outboard rails slidably coupled to a pair of outboard tracks and an inboard seating assembly disposed on an inboard rail slidably coupled to an inboard track. A release bar assembly is disposed below the outboard seating assembly and the inboard seating assembly, and includes a driver movable between a first position and a second position. A latch mechanism is operably coupled to the driver such that if the driver is in the first position, then the latch mechanism is in a locked position, and if the driver is in the second position, then the latch mechanism is in an unlocked position.

Embodiments of the first aspect of the disclosure can include any one or a combination of the following features:
in the locked position of the latch mechanism, the outboard rails and the inboard rail are engaged to the outboard tracks and the inboard track, respectively;
in the unlocked position of the latch mechanism, the outboard rails and the inboard rail are disengaged from the outboard tracks and the inboard track, respectively;
the release bar assembly includes first and second disengagement mechanisms disposed proximate each of the outboard rails and a third disengagement mechanism disposed proximate the inboard rail;
the release bar assembly further includes a disengagement actuator operably coupled to the latch mechanism and the third disengagement mechanism;
a cable assembly operably couples the disengagement actuator to the latch mechanism;
an inboard release bar operably couples the disengagement actuator to the third disengagement mechanism;
movement of the disengagement actuator from an engaged position to a disengaged position causes the inboard release bar to rotate to move the third disengagement mechanism from an engaged position to a disengaged position;
a mounting device disposed above the outboard rail adjacent to the inboard seating assembly and including an outboard mounting portion configured to receive an outboard seat frame and an inboard mounting portion configured to receive an inboard seat frame;
the mounting device includes a front bracket and a rear plate;
if the outboard rails and the inboard rail are disengaged from the outboard tracks and the inboard track, respectively, then the outboard seating assembly and the inboard seating assembly are slidable between front ends of the outboard tracks and a front end of the inboard track and back ends of the outboard tracks and a back end of the inboard track; and/or
the driver includes a handle bar.

According to another aspect of the present disclosure, a vehicle seating assembly includes a first seating assembly mounted to a pair of opposing first rails coupled to a pair of opposing first tracks and a second seating assembly mounted to a second rail coupled to a second track and one of the pair of opposing first rails. A mounting device is disposed above the one of the pair of opposing first rails and includes a first mounting portion for receiving the first seating assembly and a second mounting portion for receiving the second seating assembly. A latch mechanism is operably coupled to first and second disengagement mechanisms disposed above the pair of opposing first rails and is operably coupled to a third disengagement mechanism disposed above the second rail, wherein the latch mechanism is movable from a locked position to an unlocked position to substantially simultaneously move the first, second, and third disengagement mechanisms from engaged positions to disengaged positions.

Embodiments of the second aspect of the disclosure can include any one or a combination of the following features:
the first seating assembly includes an outboard seating assembly, wherein the second seating assembly includes an inboard seating assembly;
a disengagement actuator disposed between the latch mechanism and the third disengagement mechanism;
a cable assembly extends between the latch mechanism and the disengagement actuator, wherein exertion of a force on the cable assembly moves the disengagement actuator from an engaged position to a disengaged position; and/or
an inboard release bar extends between the disengagement actuator and the third disengagement mechanism.

According to another aspect of the present disclosure, a vehicle seating assembly includes an outboard seating assembly disposed on outboard rails releasably coupled to outboard tracks and an inboard seating assembly disposed on an inboard rail releasably coupled to an inboard track. The vehicle seating assembly also includes a mounting device for mounting the outboard seating assembly and the inboard seating assembly to one of the outboard rails, and a release bar assembly extending below the outboard seating assembly and the inboard seating assembly and including a driver movable between a first position and a second position, wherein if the driver is in the first position, then the outboard rails are fixedly coupled to the outboard tracks and the inboard rail is fixedly coupled to the inboard track, and wherein if the driver is in the second position, then the outboard rails are slidably coupled to the outboard tracks and the inboard rail is slidably coupled to the inboard track.

Embodiments of the third aspect of the disclosure can include any one or a combination of the following features:
the release bar assembly includes a latch mechanism operably coupled to the driver, operably coupled to outboard disengagement mechanisms disposed proximate the outboard rails, and operably coupled to an inboard disengagement mechanism disposed proximate the inboard rail; and/or
movement of the latch mechanism from a locked position to an unlocked position activates a disengagement actuator and an inboard release bar to move the inboard disengagement mechanism from an engaged position to a disengaged position.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a perspective view of a bench seating assembly including two outboard seating assemblies and an inboard seating assembly, according to an aspect of the disclosure;

FIG. 2 is a perspective view of a bench seating assembly including an outboard seating assembly and an inboard seating assembly, according to an aspect of the disclosure;

FIG. 3 is a perspective view of an inboard seating assembly frame, according to an aspect of the disclosure;

FIG. 4 is a side perspective view of an inboard seat frame and a mounting device, according to an aspect of the disclosure;

FIG. 5 is a right side perspective view of the inboard seat frame of FIG. 4;

FIG. 6 is a right side perspective view of a front bracket shown in FIG. 5;

FIG. 7 is a right side perspective view of a rear plate shown in FIG. 5;

FIG. 8 is a front perspective view of a portion of the inboard seat frame, according to an aspect of the disclosure;

FIG. 9 is a top perspective view of a portion of the inboard seat frame, according to an aspect of the disclosure;

FIG. 10 is a front perspective view of a portion of the inboard seat frame, the inboard release bar, and the disengagement actuator, according to an aspect of the disclosure;

FIG. 11 is a bottom perspective view of the outboard seat and a portion of the inboard seat including the latch mechanism and the disengagement mechanism, according to an aspect of the disclosure;

FIG. 12 is a front perspective view of the outboard seating assembly, portions of the inboard seat frame, and the handle bar of the release bar assembly, according to an aspect of the disclosure;

FIG. 13 is a bottom perspective view of FIG. 12;

FIG. 14 is a back perspective view of an outboard seating assembly and an inboard seating assembly coupled to the vehicle floor, according to an aspect of the disclosure;

FIG. 15 is a side elevational view of an exemplary rail and an exemplary track, according to an aspect of the disclosure;

FIG. 16 is a cross-sectional view taken along line XVI-XVI of FIG. 8 of the disengagement actuator, the outboard rail, and the outboard track with the outboard rail in the engaged position;

FIG. 17 is a cross-sectional view taken along line XVI-XVI of FIG. 8 of the disengagement actuator, the outboard rail, and the outboard track with the outboard rail in the disengaged position; and

FIG. 18 is a flow diagram showing an exemplary process of releasing the inboard rail from the inboard track and releasing the outboard rails from the outboard tracks, according to an aspect of the disclosure.

### DETAILED DESCRIPTION

With reference to the seating assemblies 10, 14, 18, 22 described below and shown in the attached figures, seating assemblies 10, 14, 18, 22 may be described from the vantage point of an occupant seated in the seating assemblies 10, 14, 18, 22. The sides of seating assemblies 10, 14, 18, 22 disposed on a right side of a seated occupant may be referred to as a right side of the seating assemblies 10, 14, 18, 22. The sides of seating assemblies 10, 14, 18, 22 disposed on a left side of seated occupant may be referred to as a left side of the seating assemblies 10, 14, 18, 22.

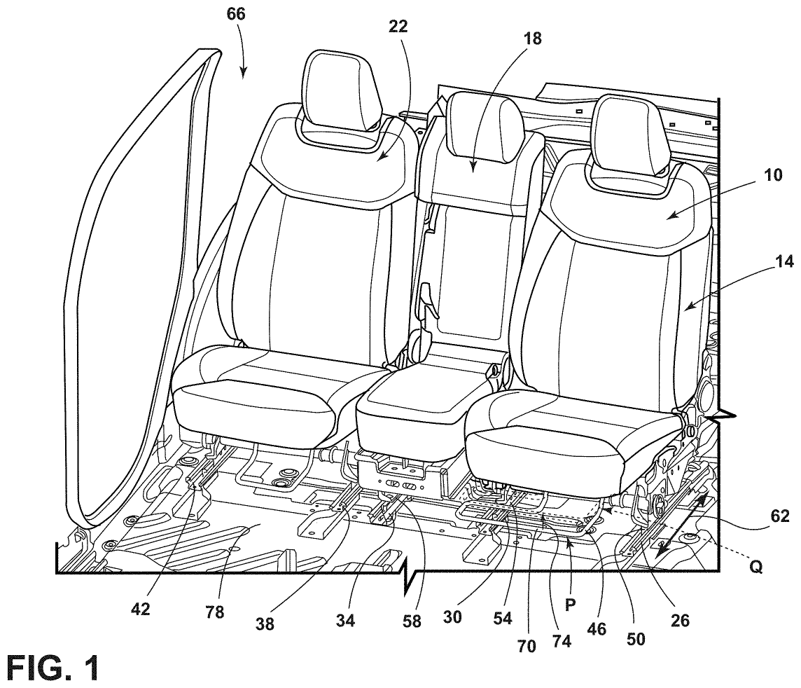

Referring now to FIG. 1, a front perspective view of a bench seating assembly 10 is shown. The bench seating assembly may include outboard seating assembly 14, inboard seating assembly 18, and outboard seating assembly 22. The outboard seating assembly 14 and the inboard seating assembly 18 may be coupled to one another so that the outboard seating assembly 14 and the inboard seating assembly 18 may slide together along the tracks 26, 30 disposed beneath the outboard seating assembly 14 and the inboard track 34 disposed below the inboard seating assembly 18. Tracks 38, 42 may be disposed below outboard seating assembly 22. A release bar assembly 46 may be disposed beneath the outboard seating assembly 14 and the inboard seating assembly 18 to release the outboard rails 50 and 54 and the inboard rail 58 from the respective outboard tracks 26 and 30 and the inboard track 34 so that the outboard seating assembly 14 and the inboard seating assembly 18 may simultaneously slide along the outboard tracks 26 and 30 and the inboard track 34 in a fore and aft direction (represented by arrow 62) in the vehicle 66. The release bar assembly 46 may include a handle bar 70 that may be subject to a force F1 (represented by arrow 74) and moved from a first position P to a second position Q to release the outboard rails 50 and 54 and the inboard rail 58 from the respective outboard tracks 26 and 30 and the inboard track 34. The outboard tracks 26 and 30 and the inboard track 34 may extend along a vehicle floor 78.

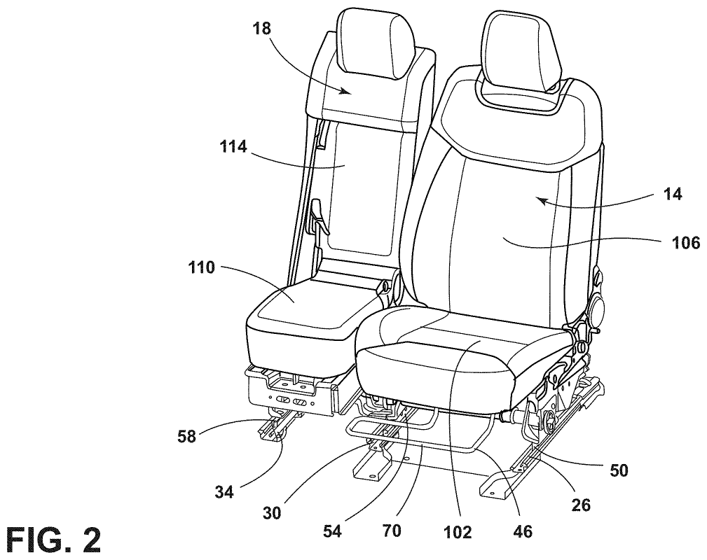

With reference to FIG. 2, a perspective view is shown with the outboard seating assembly 14 and the inboard seating assembly 18. The outboard seating assembly 14 may be disposed on a pair of opposing outboard rails 50 and 54. The pair of opposing outboard rails 50 and 54 may be slidably coupled to a pair of opposing outboard tracks 26 and 30. The inboard seating assembly 18 may be disposed on inboard rail 58. The inboard rail 58 may be slidable in the inboard track 34. The handle bar 70 of the release bar assembly 46 may extend from the front of the outboard seat 102. The outboard seating assembly 14 may include an outboard seat 102 and an outboard seatback 106. The inboard seating assembly 18 may include an inboard seat 110 and an inboard seatback 114

Referring to FIGS. 1-18, a bench seating assembly 10 for a vehicle 66 includes an outboard seating assembly 14 disposed on a pair of outboard rails 50, 54 slidably coupled to a pair of outboard tracks 26, 30 and an inboard seating assembly 18 disposed on an inboard rail 58 slidably coupled to an inboard track 34. The bench seating assembly 10 also includes a release bar assembly 46 disposed below the outboard seating assembly 14 and the inboard seating assembly 18. The release bar assembly 46 includes a driver (for example, handle bar 70) movable between a first position P and a second position Q and a latch mechanism 234 operably coupled to the driver (for example, handle bar 70). If the driver (for example, handle bar 70) is in the first position P, then the latch mechanism 234 is in a locked position L, and if the driver (for example, handle bar 70) is in the second position Q, then the latch mechanism 234 is in an unlocked position M.

Referring again to FIGS. 1-2, a seating assembly occupant may wish to slide an outboard seating assembly 14 and an inboard seating assembly 18 together along the outboard tracks 26, 30 and the inboard track 34 disposed below the outboard seating assembly 14 and the inboard seating assembly 18, respectively. Therefore, it may be desirable to have the release bar assembly 46 disposed below the outboard seating assembly 14 and the inboard seating assembly 18. The release bar assembly 46 extending below the outboard seating assembly 14 and the inboard seating assembly 18 may be designed to simultaneously release the outboard rails 50 and 54 from the outboard tracks 26 and 30 and the inboard rail 58 from the inboard track 34. It should be understood that the outboard seating assembly 22 and the inboard seating assembly 18 may share a release bar assembly 46 in another aspect of the disclosure.

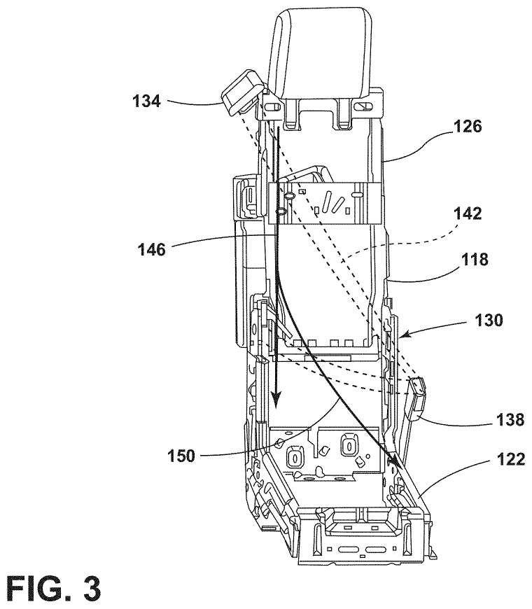

Referring to FIG. 3, a perspective view is shown of the inboard seating assembly frame 118. The inboard seating assembly frame 118 may include an inboard seat frame 122 and an inboard seatback frame 126. The inboard seating assembly 18 may include an occupant restraint 130. The occupant restraint 130 may include a pre-tensioner 134, a latch 138, and a seatbelt 142. The design of the inboard seating assembly frame 118 and the occupant restraint 130 may provide for load paths, shown by arrows 146 and 150, from a force exerted on the occupant restraint 130. The load paths may extend along the inboard seating assembly frame 118.

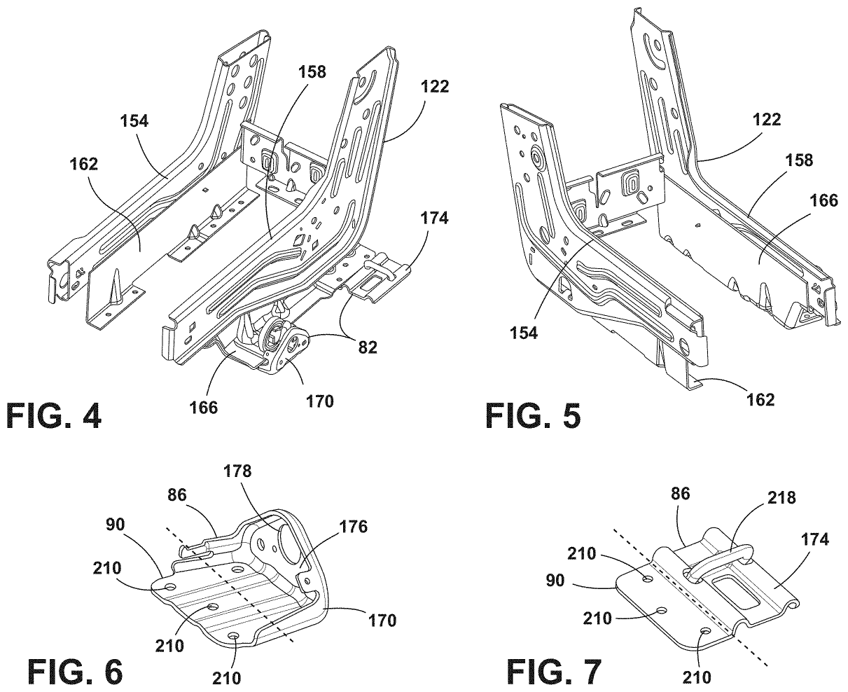

Referring to FIGS. 4-5, the inboard seat frame 122 is shown mounted on the mounting device 82. The inboard seat frame 122 may include right and left side brackets 154, 158. A right side mounting flange 162 may be disposed proximate the right side bracket 154. A left side mounting flange 166 may be disposed proximate the left side bracket 158. The right side mounting flange 162 may attach the inboard seat frame 122 to the inboard rail 58. The left side mounting flange 166 may attach the inboard seat frame 122 to the mounting device 82. The mounting device 82 may include an outboard mounting portion 86 (also referred to as the first portion of the mounting device 82) for mounting the outboard seating assembly 14 to the mounting device 82. The mounting device 82 may include an inboard mounting portion 90 (also referred to as the second portion of the mounting device 82) for mounting the inboard seat frame 122 to the mounting device 82.

Referring now to FIGS. 6-7, in the examples shown, the mounting device 82 may include a front bracket 170 and a rear plate 174. The front bracket 170 and the rear plate 174 may be attached to the outboard rail 54 disposed below the outboard seating assembly 14. Holes 210 may be provided on the front bracket 170 and the rear plate 174. Fasteners may extend through the holes 210 to mount the left side mounting flange 166 and the front bracket 170 to the outboard rail 54. Fasteners may extend through the holes 210 to mount the left side mounting flange 166 and the rear plate 174 to the outboard rail 54. The front bracket 170 may include an upward extending flange 176. The upward extending flange 176 may include an aperture 178. The aperture 178 may receive a cross member 182 that may extend along a front of the outboard seating assembly 14. The outboard seating assembly 14 may rotate around an axis of rotation defined by the cross member 182. The outboard seating assembly 14 may rotate between a sitting position and a standing position. In the standing position, the outboard seating assembly 14 may provide space for occupant egress from the vehicle 66 from behind the outboard seating assembly 14.

Referring again to FIGS. 6-7, the rear plate 174 may include a striker 218. The striker 218 may be used to secure the outboard seat frame 186 to the vehicle 66 when the outboard seating assembly 14 is in the sitting position. The outboard seating assembly 14 may be released from the striker 218 to move the outboard seating assembly 14 from a sitting position to a standing position to allow for access to the vehicle area behind the outboard seating assembly 14.

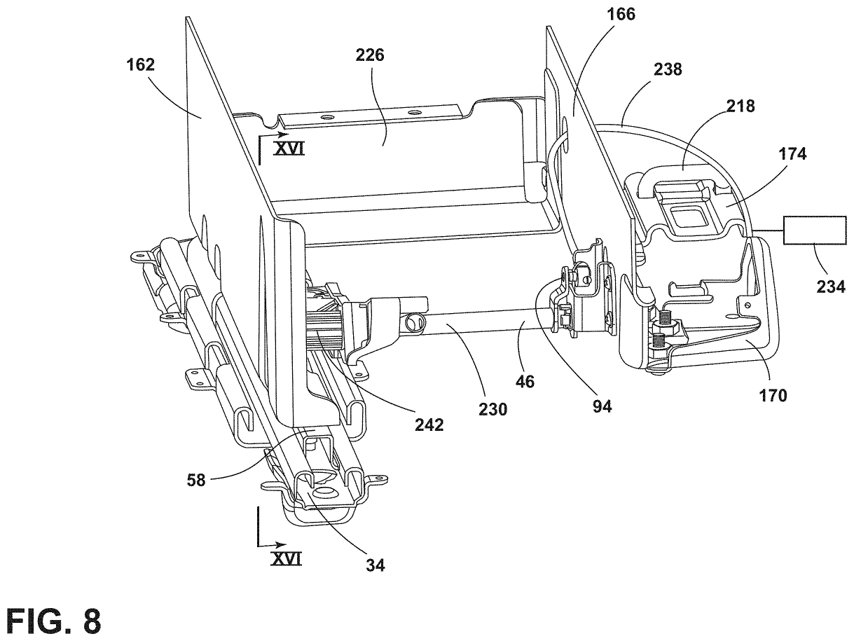

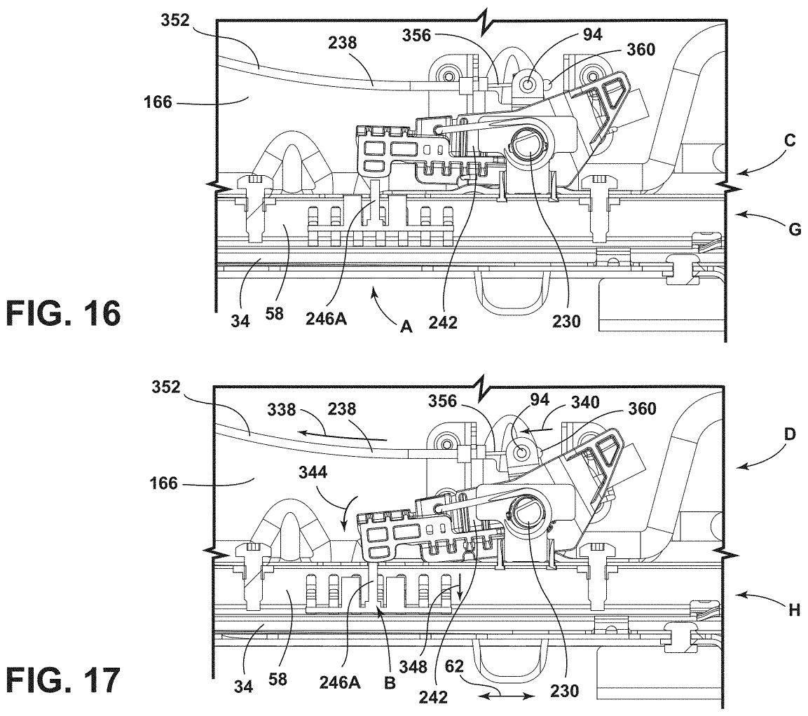

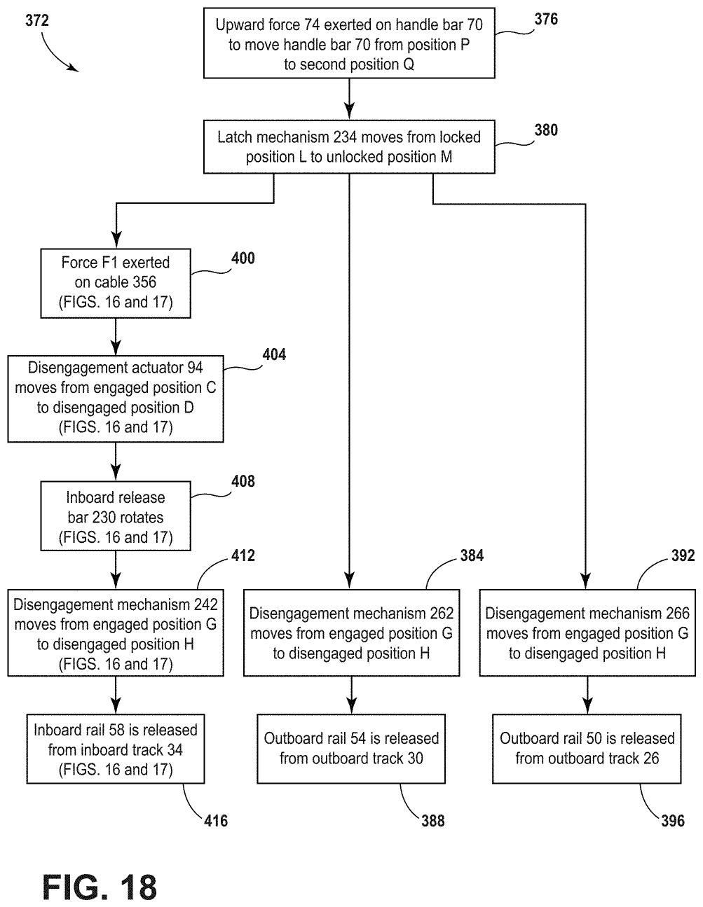

With reference to FIG. 8, parts of the inboard seat frame 122 are shown. The right side mounting flange 162 of the inboard seat frame 122 may be mounted to the inboard rail 58. The left side mounting flange 166 of the inboard seat frame 122 may be mounted to the front bracket 170 and the rear plate 174. A rear bracket 226 may extend between the right side mounting flange 162 and the left side mounting flange 166. An inboard release bar 230 of the release bar assembly 46 is shown extending between the right side mounting flange 162 and the left side mounting flange 166. The release bar assembly 46 may be activated by a release of a latch mechanism 234 that may be coupled to the outboard seating assembly 14. The latch mechanism 234 may actuate the inboard release bar 230 of the release bar assembly 46 through the cable assembly 238. The cable assembly 238 may exert a force F2 on the disengagement actuator 94. The disengagement actuator 94 may turn the inboard release bar 230 to cause the inboard release bar 230 to activate the disengagement mechanism 242 disposed above the inboard rail 58. The disengagement mechanism 242 may include pins 246A that may be moved from extended positions A to retracted positions B to allow the inboard rail 58 to slide along the inboard track 34. See, FIGS. 16-17.

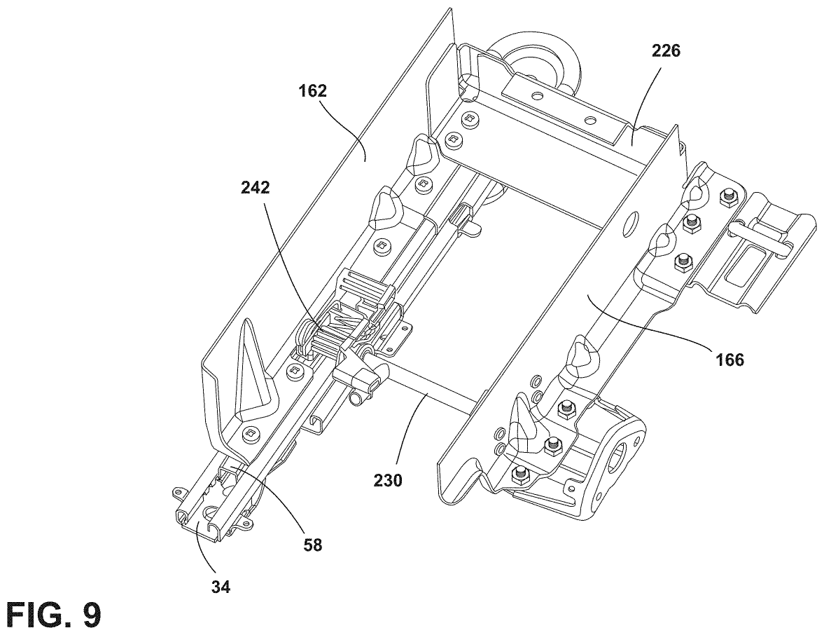

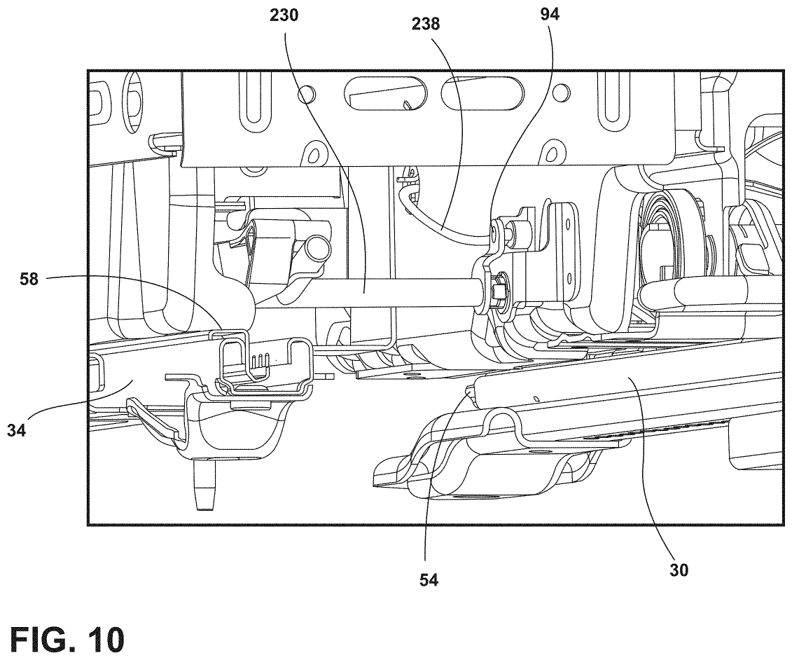

Referring now to FIGS. 9-10, views of parts of the inboard seat frame 122 are shown. The inboard seat frame 122 may include the right side mounting flange 162 and the left side mounting flange 166. The disengagement mechanism 242 may be disposed above the inboard rail 58. The disengagement mechanism may 242 may be coupled to the inboard release bar 230. The inboard release bar 230 may translate the motion of the disengagement actuator 94 to the disengagement mechanism 242. As such, when the latch mechanism 234 activates the disengagement mechanisms 262 and 266 to release the outboard rails 54 and 50 from the outboard tracks 30 and 26, then the disengagement actuator 94 may activate the inboard release bar 230 to activate the disengagement mechanism 242 to release the inboard rail 58 from the inboard track 34.

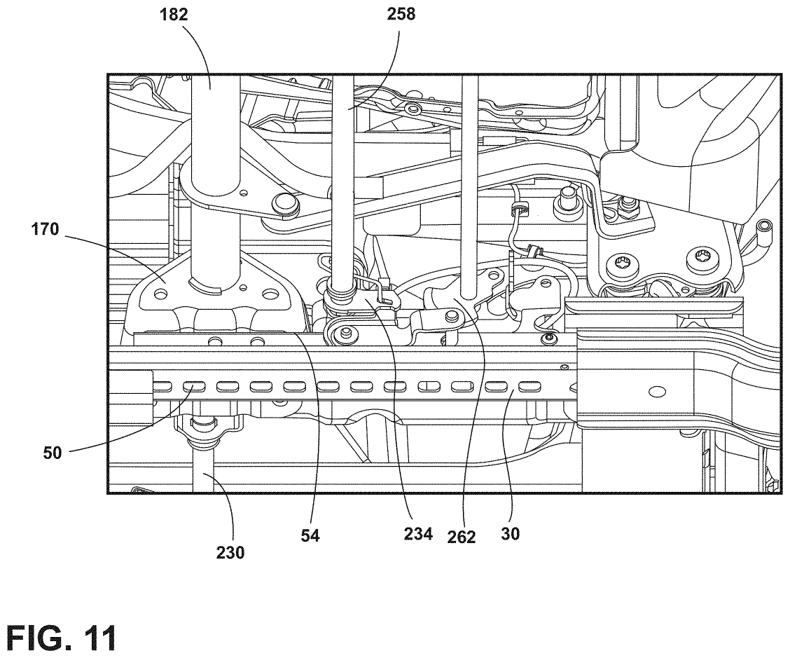

Referring now to FIGS. 11-13, when the latch mechanism 234 activates the disengagement mechanism 262 to release the outboard rail 54 from the outboard track 30, then the latch mechanism 234 may also activate the outboard release bar 258 to activate the disengagement mechanism 266 to release the outboard rail 50 from the outboard track 26. As such, the outboard seating assembly 14 and the inboard seating assembly 18 may simultaneously slide along the outboard tracks 26, 30 and the inboard track 34 in the fore and aft direction shown by arrow 62. It is to be understood that exertion of a force F1 on the handle bar 70 in an upward direction shown by arrow 74 may activate the latch mechanism 234 to disengage the disengagement mechanisms 242, 262, and 266.

Referring to FIG. 11, the outboard track 30 may include slots 250 for receiving pins 246 that may extend through the outboard rail 54 and the outboard track 30 when the outboard rail 54 is in the engaged position G. The inboard release bar 230 may extend away from the outboard track 30. The outboard release bar 258 may extend away from the outboard track 30. The front bracket 170 may be mounted to the outboard rail 54 and may receive the cross member 182.

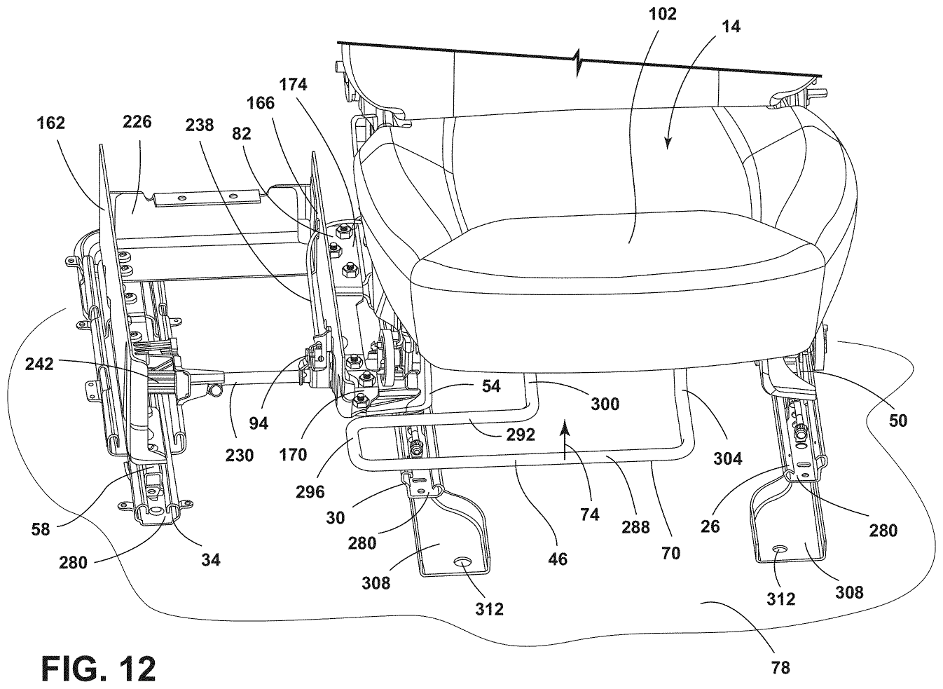

With reference to FIG. 12, the outboard seating assembly 14 is shown adjacent to parts of the inboard seat frame 122. The release bar assembly 46 may extend in front of the outboard seating assembly 14 when the outboard seating assembly 14 is disposed toward the back of the outboard tracks 26, 30. When the outboard seating assembly 14 is disposed toward the front of the outboard tracks 26 and 30, then the release bar assembly 46 may be below the outboard seating assembly 14. An occupant of the inboard seating assembly 18 may pull upward on the handle bar 70 in the direction shown by arrow 74, thus exerting a force F1 on the handle bar 70, to actuate the latch mechanism 234 to release the outboard rails 50 and 54 and the inboard rail 58 from the outboard tracks 26, 30 and the inboard track 34. The outboard tracks 26, 30 and the inboard track 34 may each include a front end 280 and a back end 284. The outboard rails 50 and 54 and the inboard rail 58 may slide from the front end 280 of the outboard tracks 26 and 30 and the front end 280 of the inboard track 34 to the back end 284 of the outboard tracks 26 and 30 and the inboard track 34. In some examples, the release bar assembly 46 may remain below the outboard seat 102 when the outboard seat 102 is disposed toward the back ends 284 of the outboard tracks 26 and 30.

With continued reference to FIG. 12, the handle bar 70 of the release bar assembly 46 may include two substantially parallel lateral segments 288, 292 extending laterally across the outboard seat 102. Longitudinal segments 296, 300, 304 may extend from one or more of the two substantially parallel lateral segments 288, 292. The lateral segments 288, 292 may extend toward the inboard seating assembly 18. The lateral segment 288 may define a handle bar 70 that may extend in front of the outboard seating assembly 14 and the inboard seating assembly 18 so that occupants seated in either one of the outboard seating assembly 14 and the inboard seating assembly 18 may conveniently reach the handle bar 70. Occupants of the outboard seating assembly 14 and the inboard seating assembly 18 may exert a force F1 (depicted by arrow 74) in an upward direction on lateral segment 288 to release outboard rails 50, 54 from the outboard tracks 26, 30 and to release the inboard rail 58 from the inboard track 34.

With continued reference to FIG. 12, the inboard release bar 230 of the release bar assembly 46 may extend between the right side mounting flange 162 and the left side mounting flange 166 of the inboard seat frame 122. The disengagement actuator 94 may be disposed proximate the left side mounting flange 166 of the inboard seat frame 122. The cable assembly 238 may extend from the latch mechanism 234 to the disengagement actuator 94. The disengagement mechanism 242 may be proximate the inboard rail 58. The outboard seat 102 and the inboard seat 110 may each be coupled to the front bracket 170 and the rear plate 174 of the mounting device 82. The outboard tracks 26, 30 may be attached to the vehicle floor 78 with mounts 308. The mounts 308 may include holes 312 for disposing fasteners through the mounts 308 to secure the mounts 308 to the vehicle floor 78.

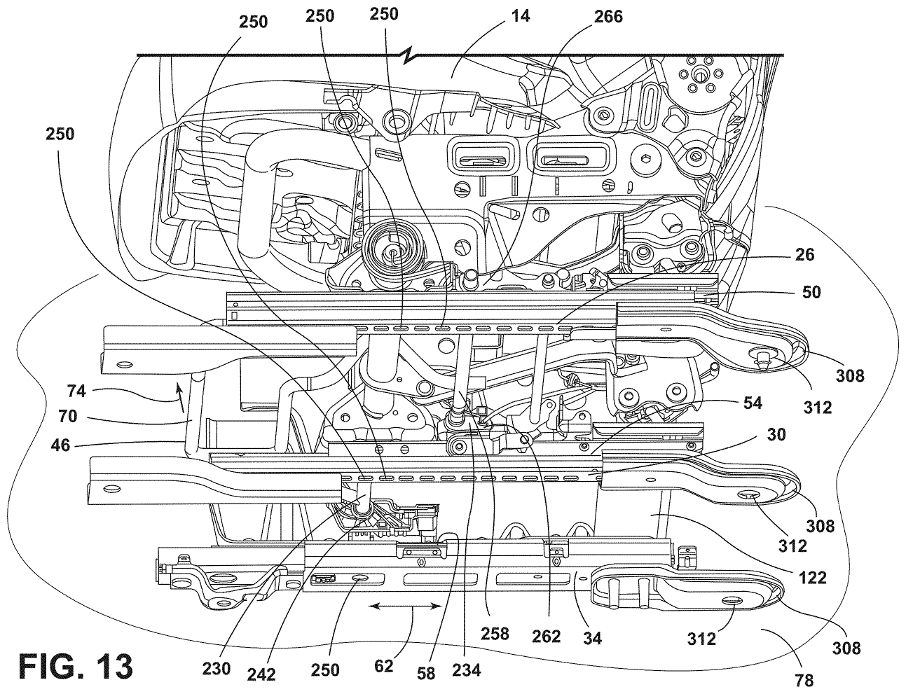

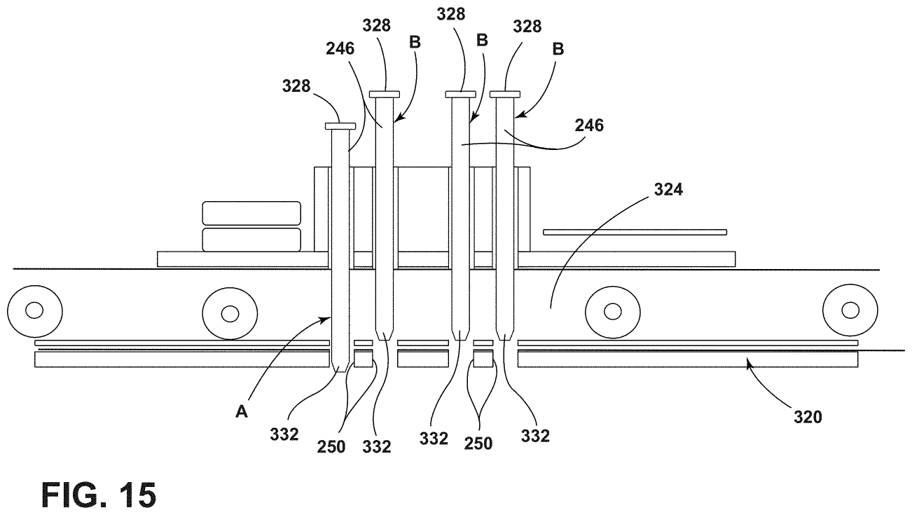

Referring now to FIG. 13, the outboard seating assembly 14 may be disposed above the outboard rails 50 and 54. The inboard seat frame 122 is shown disposed above the inboard rail 58. Various mounts 308 may secure the outboard tracks 26 and 30 and the inboard track 34 to the vehicle floor 78. The release bar assembly 46 may be below the outboard seating assembly 14 and the inboard seat frame 122. The latch mechanism 234 may be movably coupled to the disengagement actuator 94. The outboard release bar 258 may extend between the disengagement mechanism 262 and the disengagement mechanism 266. Movement of the latch mechanism 234 between the locked position L and the unlocked position M may cause the disengagement mechanism 262 to move from the engaged position G to the disengaged position H and may cause the outboard release bar 258 to move the disengagement mechanism 266 between the engaged position G and the disengaged position H. As the disengagement mechanisms 242, 262, and 266 move between the engaged and the disengaged positions G, H, the pins 246 disposed through the slots 250 in the inboard track 34 and the outboard tracks 30, 26 move from extended positions A to retracted positions B so that the outboard rails 50 and 54 and the inboard rail 58 may slide fore and aft along the outboard tracks 26 and 30 and the inboard track 34. See, FIG. 15.

With continued reference to FIG. 13, the latch mechanism 234 may be coupled to disengagement actuator 94. As the latch mechanism 234 moves from the locked position L to the unlocked position M, a cable assembly 238 extending between the latch mechanism 234 and the disengagement actuator 94 may cause the disengagement actuator 94 to move from the locked position L to the unlocked position M.

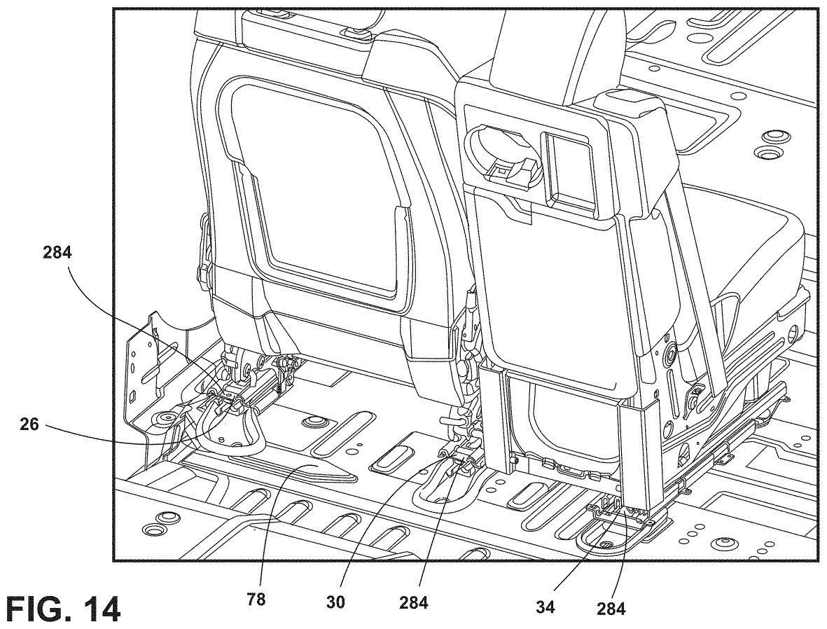

With reference to FIG. 14, the inboard seating assembly 18 and the outboard seating assembly 14 may be disposed on a vehicle floor 78. Outboard tracks 26 and 30 and inboard track 34 may include back ends 284

With reference to FIG. 15, an exemplary arrangement of pins 246 for securing an exemplary rail 324 to an exemplary track 320 at various positions along the exemplary track 320 is shown. The exemplary track 320 may be similar to outboard tracks 26, 30, and inboard track 34 shown and described above. The exemplary rail 324 may be similar to outboard rails 50, 54 and inboard rail 58 shown and described above. The pins 246 may extend through the exemplary rails 324. The pins 246 may be in a retracted position B when the exemplary rail 324 is moving along the exemplary track 320 to slide the seating assembly fore and aft along the exemplary tracks 320. The pins 246 may be in an extended position A when the exemplary rails 324 are fixed to the exemplary tracks 320. In the extended position A, the pins 246 extend through slots 250 in the exemplary track 320. The slots 250 may extend along the length of the exemplary tracks 320 such that a seating assembly (for example, outboard seating assembly 14) may be locked to the exemplary track 320 at various locations by extending the pins 246 into the slots 250 in the exemplary track 320. In various examples, the slots 250 may extend along a portion of the length of the exemplary track 320 or the entire length of the exemplary track 320. The pins 246 may be configured to have at least one of the pins 246 engage with the slots 250 in the exemplary track 320 when the pins 246 are in an extended position A. The pins 246 may be provided with a cross piece 328 that may be positioned transverse to a slot 250. The pins 246 may include tapered ends 332 that may be opposite the cross piece 328. The tapered ends 332 may allow the pins 246 to engage with the slots 250 even when the pins 246 and the slots 250 are slightly offset from one another. The cross pieces 328 may limit the extension of the pins 246 into the slots 250 while also providing a surface that may be engaged by a release mechanism. The release mechanism may raise or retract the pin(s) 246 from the slot(s) 250. The release mechanism may engage with an underside surface of the cross piece 328 such that actuation of the release mechanism may vertically displace a pin 246 to disengage the pin 246 from the slot 250 in the exemplary track 320. In various examples, the release mechanism may include disengagement mechanisms 262 and 266.

Referring now to FIGS. 16 and 17, the disengagement actuator 94 is shown in an engaged position C (FIG. 16) and a disengaged position D (FIG. 17). The inboard rail 58 is shown in an engaged position G (FIG. 16) relative to the inboard track 34 and a disengaged position H (FIG. 17) relative to the inboard track 34. The inboard rail 58 may be moved from the engaged position G to the disengaged position H to release the inboard rail 58 from the inboard track 34 so that the inboard rail 58 may slide along the inboard track 34 to move the inboard seating assembly 18 in the fore and aft direction along the inboard track 34 shown by arrow 62.

With continued reference to FIGS. 16 and 17, when the latch mechanism 234 exerts an actuating force F2 (shown by arrow 338) on the disengagement actuator 94, the disengagement actuator 94 may move in the direction shown by arrow 340 from the engaged position C to the disengaged position D. Movement of the disengagement actuator 94 in the direction shown by arrow 340 may cause the inboard release bar 230 of the release bar assembly 46 to rotate so that the disengagement mechanism 242 rotates downward in the direction shown by arrow 344. Movement of the disengagement mechanism 242 in the direction shown by arrow 344 may cause the pin 246A that may extend through the inboard rail 58 to be depressed so that the inboard rail 58 may be released from the inboard track 34. Release of the inboard rail 58 from the inboard track 34 may allow the inboard seating assembly 18 to slide along the inboard track 34 in the fore and aft direction shown by arrow 62.

With continued reference to FIGS. 16 and 17, the pin 246A may be in the extended position A, as shown in FIG. 16, if the inboard rail 58 is in the engaged position G relative to the inboard track 34. The pin 246A may be in the retracted position B, as shown in FIG. 17, if the inboard rail 58 is in the disengaged position H relative to the inboard track 34.

Referring to FIG. 18, a flow diagram is shown of the method 372 for releasing the outboard rails 50, 54 from the outboard tracks 26, 30 substantially simultaneously with the release of the inboard rail 58 from the inboard track 34 so that the outboard seating assembly 14 and the inboard seating assembly 18 may move simultaneously along the outboard tracks 26, 30 and the inboard track 34 in the fore and aft direction shown by arrow 62. Step 376 involves exerting an upward force F1 (depicted by arrow 74) on the handle bar 70 to move the handle bar 70 from the first position P to the second position Q. Step 380 includes moving the latch mechanism 234 from the locked position L to the unlocked position M. Steps 384 and 388 relate to disengagement of the outboard rail 54 from the outboard track 30. At step 384, a disengagement mechanism 262 moves from an engaged position G to a disengaged position H. At step 388, the outboard rail 54 is released from the outboard track 30. Steps 392 and 396 relate to disengagement of the outboard rail 50 from the outboard track 26. At step 392, the disengagement mechanism 266 moves form the engaged position G to the disengaged position H. At step 396, the outboard rail 50 is released from the outboard track 26. Steps 400-416 refer to disengagement of the inboard rail 58 from the inboard track 34. Referring now to step 400, the force F1 may be exerted on cable 356. Afterwards, in step 404, the disengagement actuator 94 may move from the engaged position C to the disengaged position D. In step 408, the inboard release bar 230 may rotate. Step 412 provides for moving the disengagement mechanism 242 from an engaged position G to a disengaged position H. Step 416 includes releasing inboard rail 58 from inboard track 34.

Referring to FIGS. 1-18, a vehicle seating assembly (for example, bench seating assembly 10) may include a first seating assembly (for example, outboard seating assembly 14) mounted to a pair of opposing first rails (for example, outboard rails 50, 54) coupled to a pair of opposing first tracks (for example, outboard tracks 26, 30). The vehicle seating assembly (for example, bench seating assembly 10) may also include a second seating assembly (for example, inboard seating assembly 18) mounted to a second rail (for example, inboard rail 58) coupled to a second track (for example, inboard track 34) and one of the pair of opposing first rails (for example, outboard rail 54). A mounting device 82 may be disposed above the one of the pair of opposing first rails (for example, outboard rail 54) and may include a first mounting portion (for example, outboard mounting portion 86) for receiving the first seating assembly (for example, outboard seating assembly 14) and a second mounting portion (for example, inboard mounting portion 90) for receiving the second seating assembly (for example, inboard seating assembly 18). A latch mechanism 234 may be operably coupled to the first and second engagement mechanisms 266, 262 disposed above the pair of opposing first rails (for example, outboard rails 50, 54) and operably coupled to a third disengagement mechanism 242 disposed above the second rail (for example, inboard rail 58). The latch mechanism 234 may be movable from a locked position L to an unlocked position M to substantially simultaneously move the first, second, and third disengagement mechanisms 266, 262, 242 from engaged positions G to disengaged positions H.

A variety of advantages may be achieved by use of the present disclosure. A release bar assembly 46 may disengage an inboard rail 58 when the outboard rails 50 and 54 are disengaged to allow simultaneous fore and aft movement of an outboard seating assembly 14 and an inboard seating assembly 18. An inboard seating assembly 18 may be attached to an outboard seating assembly 14. A mounting device 82 and a coupling assembly (for example, latch mechanism 234 and disengagement actuator 94) may facilitate operable coupling of the inboard seating assembly 18 to the outboard seating assembly 14.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A bench seating assembly for a vehicle comprising:
an outboard seating assembly disposed on a pair of outboard rails slidably coupled to a pair of outboard tracks;
an inboard seating assembly disposed on an inboard rail slidably coupled to an inboard track;
a release bar assembly disposed below the outboard seating assembly and the inboard seating assembly and including:
a driver movable between a first position and a second position; and
a latch mechanism operably coupled to the driver such that if the driver is in the first position, then the latch mechanism is in a locked position, and if the driver is in the second position, then the latch mechanism is in an unlocked position.

2. The bench seating assembly for a vehicle of claim 1, wherein in the locked position of the latch mechanism, the outboard rails and the inboard rail are engaged to the outboard tracks and the inboard track, respectively.

3. The bench seating assembly for a vehicle of claim 2, wherein in the unlocked position of the latch mechanism, the outboard rails and the inboard rail are disengaged from the outboard tracks and the inboard track, respectively.

4. The bench seating assembly for a vehicle of claim 3, wherein the release bar assembly includes first and second disengagement mechanisms disposed proximate each of the outboard rails and a third disengagement mechanism disposed proximate the inboard rail.

5. The bench seating assembly for a vehicle of claim 4, wherein the release bar assembly further includes a disengagement actuator operably coupled to the latch mechanism and the third disengagement mechanism.

6. The bench seating assembly for a vehicle of claim 5, wherein a cable assembly operably couples the disengagement actuator to the latch mechanism.

7. The bench seating assembly for a vehicle of claim 6, wherein an inboard release bar operably couples the disengagement actuator to the third disengagement mechanism.

8. The bench seating assembly for a vehicle of claim 7, wherein movement of the disengagement actuator from an engaged position to disengaged position causes the inboard release bar to rotate to move the third disengagement mechanism from an engaged position to a disengaged position.

9. The bench seating assembly for a vehicle of claim 8, further comprising:
a mounting device disposed above the outboard rail adjacent to the inboard seating assembly and including:
an outboard mounting portion configured to receive an outboard seat frame; and
an inboard mounting portion configured to receive an inboard seat frame.

10. The bench seating assembly for a vehicle of claim 9, wherein the mounting device includes a front bracket and a rear plate.

11. The bench seating assembly for a vehicle of claim 3, wherein if the outboard rails and the inboard rail are disengaged from the outboard tracks and the inboard track, respectively, then the outboard seating assembly and the inboard seating assembly are slidable between front ends of the outboard tracks and a front end of the inboard track and back ends of the outboard tracks and a back end of the inboard track.

12. The bench seating assembly for a vehicle of claim 1, wherein the driver includes a handle bar.

13. A vehicle seating assembly comprising:
a first seating assembly mounted to a pair of opposing first rails coupled to a pair of opposing first tracks;
a second seating assembly mounted to a second rail coupled to a second track and one of the pair of opposing first rails;
a mounting device disposed above the one of the pair of opposing first rails and including:
a first mounting portion for receiving the first seating assembly; and
a second mounting portion for receiving the second seating assembly; and
a latch mechanism operably coupled to first and second disengagement mechanisms disposed above the pair of opposing first rails and operably coupled to a third disengagement mechanism disposed above the second rail, wherein the latch mechanism is movable from a locked position to an unlocked position to substantially simultaneously move the first, second, and third disengagement mechanisms from engaged positions to disengaged positions.

14. The vehicle seating assembly of claim 13, wherein the first seating assembly includes an outboard seating assembly and wherein the second seating assembly includes an inboard seating assembly.

15. The vehicle seating assembly of claim 14, further comprising:
a disengagement actuator disposed between the latch mechanism and the third disengagement mechanism.

16. The vehicle seating assembly of claim 15, wherein a cable assembly extends between the latch mechanism and the disengagement actuator, and wherein exertion of a force on the cable assembly moves the disengagement actuator from an engaged position to a disengaged position.

17. The vehicle seating assembly of claim 16, wherein an inboard release bar extends between the disengagement actuator and the third disengagement mechanism.

18. A vehicle seating assembly comprising:
an outboard seating assembly disposed on outboard rails releasably coupled to outboard tracks;
an inboard seating assembly disposed on an inboard rail releasably coupled to an inboard track;
a mounting device for mounting the outboard seating assembly and the inboard seating assembly to one of the outboard rails; and
a release bar assembly extending below the outboard seating assembly and the inboard seating assembly and including:
a driver movable between a first position and a second position, wherein if the driver is in the first position, then the outboard rails are fixedly coupled to the outboard tracks and the inboard rail is fixedly coupled to the inboard track, and wherein if the driver is in the second position, then the outboard rails are slidably coupled to the outboard tracks and the inboard rail is slidably coupled to the inboard track.

19. The vehicle seating assembly of claim 18, wherein the release bar assembly includes a latch mechanism operably coupled to the driver, operably coupled to outboard disengagement mechanisms disposed proximate the outboard rails, and operably coupled to an inboard disengagement mechanism disposed proximate the inboard rail.

20. The vehicle seating assembly of claim 19, wherein movement of the latch mechanism from a locked position to an unlocked position activates a disengagement actuator and an inboard release bar to move the inboard disengagement mechanism from an engaged position to a disengaged position.
